(19) United States
(12) Patent Application Publication
(10) Pub. No.: US 2016/0297181 A1
(43) Pub. Date: Oct. 13, 2016

(54) LAMINATE

(71) Applicant: ZEON CORPORATION, Tokyo (JP)

(72) Inventor: Akihiro TANABE, Tokyo (JP)

(73) Assignee: ZEON CORPORATION, Tokyo (JP)

(21) Appl. No.: 15/038,360

(22) PCT Filed: Nov. 25, 2014
(86) PCT No.: PCT/JP2014/081029

§ 371 Date: May 20, 2016

(30) Foreign Application Priority Data
Nov. 28, 2013 (JP) 2013-245737

(51) Int. Cl. B32B 27/08; C08L 45/00; B32B 27/36; C08F 232/08; B32B 27/30; B32B 27/32

(52) U.S. Cl. CPC B32B 27/08; B32B 27/306; B32B 27/325; B32B 27/36; C08F 232/08; C08L 45/00; B32B 2307/412; B32B 2457/20; C08L 2201/08; C08L 2201/10

(57) ABSTRACT

A laminate comprised of a base film with a glass transition temperature of 60 to 160° C. on which a resin film is formed, wherein the resin film is formed using a resin composition containing a cyclic olefin polymer (A) having a protonic polar group, a cross-linking agent (B), a (meth)acrylate compound (C), a radical generator (D), and an antioxidant (E), a content of the cross-linking agent (B) in the resin composition is 5 to 40 parts by weight with respect to 100 parts by weight of the cyclic olefin polymer (A) having a protonic polar group, and a content of the (meth)acrylate compound (C) in the resin composition is 0.5 to 10 parts by weight, is provided.

### TECHNICAL FIELD

The present invention relates to a laminate obtained by forming a resin film on a a resin film, more particularly relates to a laminate excellent in interlayer adhesion and excellent in flatness and transparency.

### BACKGROUND ART

A touch palette, flexible organic EL display or other display device, an integrated circuit device, solid state imaging device, color filter, black matrix, or other electronic device is provided with a protective film for preventing deterioration or damage, a flattening film for flattening the device surface or interconnects, an electric insulating film for ensuring the electrical insulation property, etc. constituted by various types of resin films.

For example, a flexible organic EL display is comprised of a light emitting board having a light emitting layer comprised of organic EL devices on which a protective board having flexibility is laminated. The organic EL devices contained in light emitting boards have the property of ending up deteriorating in light emission properties if coming into contact with moisture or oxygen. For this reason, the protective boards are being required to have a gas barrier property again oxygen or water. Particularly, the protective boards are being required to have high flatness so as to prevent problems, when laminated with a light emitting board, such as formation of defects in the gas barrier property due to the effects of pinholes, protrusions, etc. when laminated with a light emitting board.

For example, Patent Document 1 discloses the art of forming a flattening film forming a protective board of a flexible organic EL display using a resin composition containing a cardo resin. However, in Patent Document 1, there is the problem that the adhesion between the flattening film and the base film was poor and therefore the gas barrier property is not necessarily sufficient.

Further, Patent Document 2 discloses the art of using an acrylic based resin as a resin composition for forming a resin film in a laminate comprised of a base film on which a resin film and inorganic film are formed. However, the resin film comprised of an acrylic based resin disclosed in Patent Document 2 is not sufficient in flatness and is not suitable for application as a protective board for a flexible organic EL display.

### PRIOR ART DOCUMENTS

### Patent Documents

Patent Document 1: Japanese Patent Publication No. 2004-299230A

Patent Document 2: Japanese Patent Publication No. 2004-292519A

### SUMMARY OF THE INVENTION

### Problem to be Solved by the Invention

The present invention has as its object to provide a laminate excellent in interlayer adhesion and excellent in flatness and transparency.

### Means for Solving the Problems

The inventors engaged in intensive research to achieve the above object and as a result discovered that above objects can be achieved by providing a laminate comprised of a base film having that predetermined glass transition temperature on which a resin film is formed using a resin composition containing a cyclic olefin polymer (A) having a protonic polar group, a cross-linking agent (B), a (meth)acrylate compound (C), a radical generator (D), and an antioxidant (E) and having ratios of contents of cross-linking agent (B) and (meth)acrylate compound (C) within a predetermined range, and thereby completed the present invention.

That is, according to the present invention, there are provided:

[1] a laminate obtained by forming a resin film on a base film with a glass transition temperature of 60 to 160° C., wherein the resin film is formed using a resin composition containing a cyclic olefin polymer (A) having a protonic polar group, a cross-linking agent (B), a (meth)acrylate compound (C), a radical generator (D), and an antioxidant (E), and a content of the cross-linking agent (B) in the resin composition is 5 to 40 parts by weight with respect to 100 parts by weight of the cyclic olefin polymer (A) having a protonic polar group, and a content of the (meth)acrylate compound (C) in the resin composition is 0.5 to 10 parts by weight,
[2] the laminate according to [1] wherein a content of the radical generator (D) in the resin composition is 0.3 to 8 parts by weight with respect to 100 parts by weight of the cyclic olefin polymer (A) having a protonic polar group,
[3] the laminate according to [1] or [2] wherein a content of the antioxidant (E) in the resin composition is 0.1 to 20 parts by weight with respect to 100 parts by weight of the cyclic olefin polymer (A) having a protonic polar group,
[4] the laminate according to any one of [1] to [3] wherein the (meth)acrylate compound (C) includes at least one of an alkoxysilyl group-containing (meth)acrylate compound, epoxy group-containing (meth)acrylate compound, and tetrafunctional or higher functional (meth)acrylate compound,
[5] the laminate according to any one of [1] to [4] wherein the antioxidant (E) is a phenol-based antioxidant,
[6] the laminate according to any one of [1] to [5] wherein the base film is a polyethylene naphthalate film, and
[7] the laminate according to [1] used as a protective board for a flexible organic EL display,

### Effects of the Invention

According to the present invention, it is possible to provide a laminate excellent in interlayer adhesion and excellent in flatness and transparency. The laminate of the present invention is excellent in interlayer adhesion and excellent in flatness and transparency, so can be suitably used as a protective board for a flexible organic EL display.

### DESCRIPTION OF EMBODIMENTS

The laminate of the present invention is a laminate obtained by forming a resin film on a base film with a glass transition temperature of 60 to 160° C., wherein the resin film is formed using a resin composition containing a cyclic olefin polymer (A) having a protonic polar group, a cross-linking agent (B), a (meth)acrylate compound (C), a radical generator (D), and an antioxidant (E), a content of the cross-linking agent (B) in the resin composition is 5 to 40 parts by weight with respect to 100 parts by weight of the cyclic olefin polymer (A) having a protonic polar group, and a content of the (meth)acrylate compound (C) in the resin composition is 0.5 to 10 parts by weight.

(Resin Composition)

First, a resin composition for forming a resin film forming part of the laminate of the present invention will be explained.

The resin composition used in the present invention contains a cyclic olefin polymer (A) having a protonic polar group, a cross-linking agent (B), a (meth)acrylate compound (C), a radical generator (D), and an antioxidant (E).

As the cyclic olefin polymer having a protonic polar group (A) (below, simply referred to as the “cyclic olefin polymer (A)”) used in the present invention, a polymer of one or more cyclic olefin monomers or a copolymer of one or more cyclic olefin monomers and a monomer which can copolymerize with them may be mentioned, but in the present invention, as the monomer for forming the cyclic olefin polymer (A), it is preferable to use at least a cyclic olefin monomer which has a protonic polar group (a).

Here, the “protonic polar group” means a group which contains an atom belonging to Group XV or Group XVI of the Periodic Table to which a hydrogen atom directly bonds. Among the atoms belonging to Group XV or Group XVI of the Periodic Table, atoms belonging to Period 1 or Period 2 of Group XV or Group XVI of the Periodic Table are preferable, an oxygen atom, nitrogen atom, or sulfur atom is more preferable, and an oxygen atom is particularly preferable.

As specific examples of such a protonic polar group, a hydroxyl group, carboxy group (hydroxycarbonyl group), sulfonic acid group, phosphoric acid group, and other polar groups which have oxygen atoms; primary amino group, secondary amino group, primary amide group, secondary amide group (imide group), and other polar groups which have nitrogen atoms; a thiol group and other polar groups which have sulfur atoms; etc. may be mentioned. Among these as well, ones which have oxygen atoms are preferable, carboxy group is more preferable. In the present invention, the number of protonic polar groups which bond with the cyclic olefin resin which has protonic polar groups is not particularly limited. Further, different types of protonic polar groups may also be included.

As specific examples of the cyclic olefin monomer which has a protonic polar group (a) (below, suitably called the “monomer (a)”), 2-hydroxycarbonylbicyclo[2.2.1]hept-5-ene, 2-methyl-2-hydroxycarbonylbicyclo[2.2.1]hept-5-ene, 2-carboxymethyl-2-hydroxycarbonylbicyclo[2.2.1]hept-5-ene, 2-hydroxycarbonyl-2-methoxycarbonylmethylbicyclo[2.2.1]hept-5-ene, 2-hydroxycarbonyl-2-ethoxycarbonylmethylbicyclo[2.2.1]hept-5-ene, 2-hydroxycarbonyl-2-propoxycarbonylmethylbicyclo[2.2.1]hept-5-ene, 2-hydroxycarbonyl-2-butoxycarbonylmethylbicyclo[2.2.1]hept-5-ene, 2-hydroxycarbonyl-2-pentyloxycarbonylmethylbicyclo[2.2.1]hept-5-ene, 2-hydroxycarbonyl-2-hexyloxycarbonylmethylbicyclo[2.2.1]hept-5-ene, 2-hydroxycarbonyl-2-cyclohexyloxycarbonylmethylbicyclo[2.2.1]hept-5-ene, 2-hydroxycarbonyl-2-phenoxycarbonylmethylbicyclo[2.2.1]hept-5-ene, 2-hydroxycarbonyl-2-naphthyloxycarbonylmethylbicyclo[2.2.1]hept-5-ene, 2-hydroxycarbonyl-2-biphenyloxycarbonylmethylbicyclo[2.2.1]hept-5-ene, 2-hydroxycarbonyl-2-benzyloxycarbonylmethylbicyclo[2.2.1]hept-5-ene, 2-hydroxycarbonyl-2-hydroxyethoxycarbonylmethylbicyclo[2.2.1]hept-5-ene, 2,3-dihydroxycarbonylbicyclo[2.2.1]hept-5-ene, 2-hydroxycarbonyl-3-methoxycarbonylbicyclo[2.2.1]hept-5-ene, 2-hydroxycarbonyl-3-ethoxycarbonylbicyclo[2.2.1]hept-5-ene, 2-hydroxycarbonyl-3-propoxycarbonylbicyclo[2.2.1]hept-5-ene, 2-hydroxycarbonyl-3-butoxycarbonylbicyclo[2.2.1]hept-5-ene, 2-hydroxycarbonyl-3-pentyloxycarbonylbicyclo[2.2.1]hept-5-ene, 2-hydroxycarbonyl-3-hexyloxycarbonylbicyclo[2.2.1]hept-5-ene, 2-hydroxycarbonyl-3-cyclohexyloxycarbonylbicyclo[2.2.1]hept-5-ene, 2-hydroxycarbonyl-3-phenoxycarbonylbicyclo[2.2.1]hept-5-ene, 2-hydroxycarbonyl-3-naphthyloxycarbonylbicyclo[2.2.1]hept-5-ene, 2-hydroxycarbonyl-3-biphenyloxycarbonylbicyclo[2.2.1]hept-5-ene, 2-hydroxycarbonyl-3-benzyloxycarbonylbicyclo[2.2.1]hept-5-ene, 2-hydroxycarbonyl-3-hydroxyethoxycarbonylbicyclo[2.2.1]hept-5-ene, 2-hydroxycarbonyl-3-hydroxycarbonylmethylbicyclo[2.2.1]hept-5-ene, 3-methyl-2-hydroxycarbonylbicyclo[2.2.1]hept-5-ene, 3-hydroxymethyl-2-hydroxycarbonylbicyclo[2.2.1]hept-5-ene, 2-hydroxycarbonyltricyclo[5.2.1.0^{2,6}]deca-3, 8-diene, 4-hydroxycarbonyltetracyclo[6.2.1.1^{3,6}.0^{2,7}]dodec-9-ene, 4-methyl-4-hydroxycarbonyltetracyclo[6.2.1.1^{3,6}.0^{2,7}]dodec-9-ene, 4,5-dihydroxycarbonyltetracyclo[6.2.1.1^{3,6}.0^{2,7}]dodec-9-ene, 4-carboxymethyl-4-hydroxycarbonyltetracyclo[6.2.1.1^{3,6}.0^{2,7}]dodec-9-ene, N-(hydroxycarbonylmethyl)bicyclo[2.2.1]hept-5-ene-2,3-dicarboxyimide, N-(hydroxycarbonylethyl)bicyclo[2.2.1]hept-5-ene-2,3-dicarboxyimide, N-(hydroxycarbonylpentyl)bicyclo[2.2.1]hept-5-ene-2,3-dicarboxyimide, N-(dihydroxycarbonylethyl)bicyclo[2.2.1]hept-5-ene-2,3-dicarboxyimide, N-(dihydroxycarbonylpropyl)bicyclo[2.2.1]hept-5-ene-2,3-dicarboxyimide, N-(hydroxycarbonylphenethyl)bicyclo[2.2.1]hept-5-ene-2,3-dicarboxyimide, N-(2-(4-hydroxyphenyl)-1-(hydroxycarbonyl)ethyl)bicyclo[2.2.1]hept-5-ene-2,3-dicarboxyimide, N-(hydroxycarbonylphenyl)bicyclo[2.2.1]hept-5-ene-2,3-dicarboxyimide, and other carboxy group-containing cyclic olefins; 2-(4-hydroxyphenyl)bicyclo[2.2.1]hept-5-ene, 2-methyl-2-(4-hydroxyphenyl)bicyclo[2.2.1]hept-5-ene, 4-(4-hydroxyphenyl)tetracyclo[6.2.1.1^{3,6}.0^{2,7}]dodec-9-ene, 4-methyl-4-(4-hydroxyphenyl)tetracyclo[6.2.1.1^{3,6}.0^{2,7}]dodec-9-ene, 2-hydroxybicyclo[2.2.1]hept-5-ene, 2-hydroxymethylbicyclo[2.2.1]hept-5-ene, 2-hydroxyethylbicyclo[2.2.1]hept-5-ene, 2-methyl-2-hydroxymethylbicyclo[2.2.1]hept-5-ene, 2, 3-dihydroxymethylbicyclo[2.2.1]hept-5-ene, 2-(hydroxyethoxycarbonyl)bicyclo[2.2.1]hept-5-ene, 2-methyl-2-(hydroxyethoxycarbonyl)bicyclo[2.2.1]hept-5-ene, 2-(1-hydroxy-1-trifluoromethyl-2, 2,2-trifluoroethyl)bicyclo[2.2.1]hept-5-ene, 2-(2-hydroxy-2-trifluoromethyl-3,3,3-trifluoropropyl)bicyclo[2.2.1]hept-5-ene, 3-hydroxytricyclo[5.2.1.0^{2,6}]deca-4,8-diene, 3-hydroxymethyltricyclo[5.2.1.0^{2,6}]deca-4, 8-diene, 4-hydroxytetracyclo[6.2.1.1^{3,6}.0^{2,7}]dodec-9-ene, 4-hydroxymethyltetracyclo[6.2.1.1^{3,6}.0^{2,7}]dodec-9-ene, 4,5-dihydroxymethyltetracyclo[6.2.1.1^{3,6}.0^{2,7}]dodec-9-ene, 4-(hydroxyethoxycarbonyl)tetracyclo[6.2.1.1^{3,6}.0^{2,7}]dodec-9-ene, 4-methyl-4-(hydroxyethoxycarbonyl)tetracyclo[6.2.1.1^{3,6}.0^{2,7}]dodec-9-ene, N-(hydroxyethyl)bicyclo[2.2.1]hept-5-ene-2,3-dicarboxyimide, N-(hydroxyphenyl)bicyclo[2.2.1]hept-5-ene-2,3-dicarboxyimide, and other hydroxyl group-containing cyclic olefins etc. may be mentioned. Among these as well, from the viewpoint of the adhesion of the obtained resin film becoming higher, carboxy group-containing cyclic olefins are preferable, while 4-hydroxycarbonyltetracyclo[6.2.1.1^{3,6}.0^{2,7}]dodec-9-ene is particularly preferable. These monomers (a) may respectively be used alone or may be used as two types or more combined.

In the cyclic olefin polymer (A), the ratio of content of the units of the monomer (a) is preferably 10 to 90 mol % with respect to all monomer units. If the ratio of content of the units of the monomer (a) is too small, heat resistance is liable to become insufficient, while if too great, the cyclic olefin polymer (A) is liable to become insufficient in solubility in a polar solvent.

Further, the cyclic olefin polymer (A) used in the present invention may be a copolymer which is obtained by copolymerization of a cyclic olefin monomer having a protonic polar group (a) and a monomer which can copolymerize with this. As such a copolymerizable monomer (b), a cyclic olefin monomer which has a polar group other than a protonic polar group (b1), a cyclic olefin monomer which does not have a polar group (b2), and a monomer other than a cyclic olefin (b3) (below, suitably called the “monomer (b1)”, “monomer (b2)”, and “monomer (b3)”) may be mentioned.

As the cyclic olefin monomer which has a polar group other than a protonic polar group (b1), for example, a cyclic olefin which has an N-substituted imide group, ester group, cyano group, acid anhydride group, or halogen atom may be mentioned.

As a cyclic olefin which has an N-substituted imide group, for example, a monomer represented by the following formula (1) or a monomer represented by the following formula (2) may be mentioned.

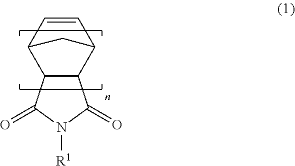

(In the above formula (1), R¹ indicates a hydrogen atom or C₁ to C₁₆ alkyl group or aryl group. “n” indicates an integer of 1 to 2.)

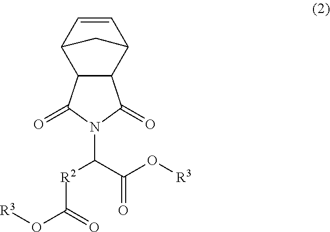

(In the above formula (2), R² indicates a C₁ to C₃ bivalent alkylene group, while R³ indicates a C₁ to C₁₀ monovalent alkyl group or a C₁ to C₁₀ monovalent halogenated alkyl group.)

In the above formula (1), R¹ is a C₁ to C₁₆ alkyl group or aryl group. As specific examples of the alkyl group, a methyl group, ethyl group, n-propyl group, n-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, and other straight chain alkyl groups; cyclopropyl group, cyclobutyl group, cyclopentyl group, cyclohexyl group, cycloheptyl group, cyclooctyl group, cyclononyl group, cyclodecyl group, cycloundecyl group, cyclododecyl group, norbornyl group, bornyl group, isobornyl group, decahydronaphthyl group, tricyclodecanyl group, adamantyl group, and other cyclic alkyl groups; 2-propyl group, 2-butyl group, 2-methyl-1-propyl group, 2-methyl-2-propyl group, 1-methylbutyl group, 2-methylbutyl group, 1-methylpentyl group, 1-ethylbutyl group, 2-methylhexyl group, 2-ethylhexyl group, 4-methylheptyl group, 1-methylnonyl group, 1-methyltridecyl group, 1-methyltetradecyl group, and other branched alkyl groups; etc. may be mentioned. Further, as specific examples of the aryl group, a benzyl group etc. may be mentioned. Among these as well, due to the more excellent heat resistance and solubility in a polar solvent, a C₆ to C₁₄ alkyl group and aryl group are preferable, while a C₆ to C₁₀ alkyl group and aryl group are more preferable. If the number of carbon atoms is 4 or less, the solubility in a polar solvent is inferior, while if the number of carbon atoms is 17 or more, the heat resistance is inferior. Further, when patterning the resin film, there is the problem that the resin film melts by heat and the patterns to end up disappearing.

As specific examples of the monomer represented by the above formula (1), bicyclo[2.2.1]hept-5-ene-2,3-dicarboxyimide, N-phenyl-bicyclo[2.2.1]hept-5-ene-2,3-dicarboxyimide, N-methylbicyclo[2.2.1]hept-5-ene-2,3-dicarboxyimide, N-ethylbicyclo[2.2.1]hept-5-ene-2,3-dicarboxyimide, N-propylbicyclo[2.2.1]hept-5-ene-2,3-dicarboxyimide, N-butylbicyclo[2.2.1]hept-5-ene-2,3-dicarboxyimide, N-cyclohexylbicyclo[2.2.1]hept-5-ene-2,3-dicarboxyimide, N-adamantylbicyclo[2.2.1]hept-5-ene-2,3-dicarboxyimide, N-(1-methylbutyl)-bicyclo[2.2.1]hept-5-ene-2,3-dicarboxyimide, N-(2-methylbutyl)-bicyclo[2.2.1]hept-5-ene-2,3-dicarboxyimide, N-(1-methylpentyl)-bicyclo[2.2.1]hept-5-ene-2,3-dicarboxyimide, N-(2-methylpentyl)-bicyclo[2.2.1]hept-5-ene-2,3-dicarboxyimide, N-(1-ethylbutyl)-bicyclo[2.2.1]hept-5-ene-2,3-dicarboxyimide, N-(2-ethylbutyl)-bicyclo[2.2.1]hept-5-ene-2,3-dicarboxyimide, N-(1-methylhexyl)-bicyclo[2.2.1]hept-5-ene-2,3-dicarboxyimide, N-(2-methylhexyl)-bicyclo[2.2.1]hept-5-ene-2,3-dicarboxyimide, N-(3-methylhexyl)-bicyclo[2.2.1]hept-5-ene-2,3-dicarboxyimide, N-(1-butylpentyl)-bicyclo[2.2.1]hept-5-ene-2,3-dicarboxyimide, N-(2-butylpentyl)-bicyclo[2.2.1]hept-5-ene-2,3-dicarboxyimide, N-(1-methylheptyl)-bicyclo[2.2.1]hept-5-ene-2,3-dicarboxyimide, N-(2-methylheptyl)-bicyclo[2.2.1]hept-5-ene-2,3-dicarboxyimide, N-(3-methylheptyl)-bicyclo[2.2.1]hept-5-ene-2,3-dicarboxyimide, N-(4-methylheptyl)-bicyclo[2.2.1]hept-5-ene-2,3-dicarboxyimide, N-(1-ethylhexyl)-bicyclo[2.2.1]hept-5-ene-2,3-dicarboxyimide, N-(2-ethylhexyl)-bicyclo[2.2.1]hept-5-ene-2,3-dicarboxyimide, N-(3-ethylhexyl)-bicyclo[2.2.1]hept-5-ene-2,3-dicarboxyimide, N-(1-propylpentyl)-bicyclo[2.2.1]hept-5-ene-2,3-dicarboxyimide, N-(2-propylpentyl)-bicyclo[2.2.1]hept-5-ene-2,3-dicarboxyimide, N-(1-methyloctyl)-bicyclo[2.2.1]hept-5-ene-2,3-dicarboxyimide, N-(2-methyloctyl)-bicyclo[2.2.1]hept-5-ene-2,3-dicarboxyimide, N-(3-methyloctyl)-bicyclo[2.2.1]hept-5-ene-2,3-dicarboxyimide, N-(4-methyloctyl)-bicyclo[2.2.1]hept-5-ene-2,3-dicarboxyimide, N-(1-ethylheptyl)-bicyclo[2.2.1]hept-5-ene-2,3-dicarboxyimide, N-(2-ethylheptyl)-bicyclo[2.2.1]hept-5-ene-2,3-dicarboxyimide, N-(3-ethylheptyl)-bicyclo[2.2.1]hept-5-ene-2,3-dicarboxyimide, N-(4-ethylheptyl)-bicyclo[2.2.1]hept-5-ene-2,3-dicarboxyimide, N-(1-propylhexyl)-bicyclo[2.2.1]hept-5-ene-2,3-dicarboxyimide, N-(2-propylhexyl)-bicyclo[2.2.1]hept-5-ene-2,3-dicarboxyimide, N-(3-propylhexyl)-bicyclo[2.2.1]hept-5-ene-2,3-dicarboxyimide, N-(1-methylnonyl)-bicyclo[2.2.1]hept-5-ene-2,3-dicarboxyimide, N-(2-methylnonyl)-bicyclo[2.2.1]hept-5-ene-2,3-dicarboxyimide, N-(3-methylnonyl)-bicyclo[2.2.1]hept-5-ene-2,3-dicarboxyimide, N-(4-methylnonyl)-bicyclo[2.2.1]hept-5-ene-2,3-dicarboxyimide, N-(5-methylnonyl)-bicyclo[2.2.1]hept-5-ene-2,3-dicarboxyimide, N-(1-ethyloctyl)-bicyclo[2.2.1]hept-5-ene-2,3-dicarboxyimide, N-(2-ethyloctyl)-bicyclo[2.2.1]hept-5-ene-2,3-dicarboxyimide, N-(3-ethyloctyl)-bicyclo[2.2.1]hept-5-ene-2,3-dicarboxyimide, N-(4-ethyloctyl)-bicyclo[2.2.1]hept-5-ene-2,3-dicarboxyimide, N-(1-methyldecyl)-bicyclo[2.2.1]hept-5-ene-2,3-dicarboxyimide, N-(1-methyldodecyl)-bicyclo[2.2.1]hept-5-ene-2,3-dicarboxyimide, N-(1-methylundecyl)-bicyclo[2.2.1]hept-5-ene-2,3-dicarboxyimide, N-(1-methyldodecyl)-bicyclo[2.2.1]hept-5-ene-2,3-dicarboxyimide, N-(1-methyltridecyl)-bicyclo[2.2.1]hept-5-ene-2,3-dicarboxyimide, N-(1-methyltetradecyl)-bicyclo[2.2.1]hept-5-ene-2,3-dicarboxyimide, N-(1-methylpentadecyl)-bicyclo[2.2.1]hept-5-ene-2,3-dicarboxyimide, N-phenyl-tetracyclo[6.2.1.1^{3,6}.0^{2,7}]dodec-9-ene-4,5-dicarboxyimide, N-(2,4-dimethoxyphenyl)-tetracyclo[6.2.1.1^{3,6}.0^{2,7}]dodec-9-ene-4,5-dicarbox yimide, etc. may be mentioned. Note that, these may respectively be used alone or may be used as two types or more combined.

On the other hand, in the above formula (2), R² is a C₁ to C₃ bivalent alkylene group. As the C₁ to C₃ bivalent alkylene group, a methylene group, ethylene group, propylene group, and isopropylene group may be mentioned. Among these as well, due to the excellent polymerization activity, a methylene group and ethylene group are preferable.

Further, in the above formula (2), R³ is a C₁ to C₁₀ monovalent alkyl group or C₁ to C₁₀ monovalent halogenated alkyl group. As the C₁ to C₁₀ monovalent alkyl group, for example, a methyl group, ethyl group, propyl group, isopropyl group, butyl group, sec-butyl group, tert-butyl group, hexyl group, cyclohexyl group, etc. may be mentioned. As the C₁ to C₁₀ monovalent halogenated alkyl group, for example, a fluoromethyl group, chloromethyl group, bromomethyl group, difluoromethyl group, dichloromethyl group, difluoromethyl group, trifluoromethyl group, trichloromethyl group, 2,2,2-trifluoroethyl group, pentafluoroethyl group, heptafluoropropyl group, perfluorobutyl group, perfluoropentyl group, etc. may be mentioned. Among these as well, since the solubility in a polar solvent is excellent, as R³, a methyl group or ethyl group is preferable.

Note that, the monomer represented by the above formulas (1) and (2) can, for example, be obtained by an imidization reaction between a corresponding amine and 5-norbornene-2,3-dicarboxylic acid anhydride. Further, the obtained monomer can be efficiently isolated by separating and refining the reaction solution of the imidization reaction by a known method.

As the cyclic olefin which has an ester group, for example, 2-acetoxybicyclo[2.2.1]hept-5-ene, 2-acetoxymethylbicyclo[2.2.1]hept-5-ene, 2-methoxycarbonylbicyclo[2.2.1]hept-5-ene, 2-ethoxycarbonylbicyclo[2.2.1]hept-5-ene, 2-propoxycarbonylbicyclo[2.2.1]hept-5-ene, 2-butoxycarbonylbicyclo[2.2.1]hept-5-ene, 2-cyclohexyloxycarbonylbicyclo[2.2.1]hept-5-ene, 2-methyl-2-methoxycarbonylbicyclo[2.2.1]hept-5-ene, 2-methyl-2-ethoxycarbonylbicyclo[2.2.1]hept-5-ene, 2-methyl-2-propoxycarbonylbicyclo[2.2.1]hept-5-ene, 2-methyl-2-butoxycarbonylbicyclo[2.2.1]hept-5-ene, 2-methyl-2-cyclohexyloxycarbonylbicyclo[2.2.1]hept-5-ene, 2-(2,2,2-trifluoroethoxycarbonyl)bicyclo[2.2.1]hept-5-ene, 2-methyl-2-(2,2,2-trifluoroethoxycarbonyl)bicyclo[2.2.1]hept-5-ene, 2-methoxycarbonyltricyclo[5.2.1.0^{2,6}]dec-8-ene, 2-ethoxycarbonyltricyclo[5.2.1.0^{2,6}]dec-8-ene, 2-propoxycarbonyltricyclo[5.2.1.0^{2,6}]dec-8-ene, 4-acetoxytetracyclo[6.2.1.1^{3,6}.0^{2,7}]dodec-9-ene, 4-methoxycarbonyltetracyclo[6.2.1.1^{3,6}.0^{2,7}]dodec-9-ene, 4-ethoxycarbonyltetracyclo[6.2.1.1^{3,6}.0^{2,7}]dodec-9-ene, 4-propoxycarbonyltetracyclo[6.2.1.1^{3,6}.0^{2,7}]dodec-9-ene, 4-butoxycarbonyltetracyclo[6.2.1.1^{3,6}.0^{2,7}]dodec-9-ene, 4-methyl-4-methoxycarbonyltetracyclo[6.2.1.1^{3,6}.0^{2,7}]dodec-9-ene, 4-methyl-4-ethoxycarbonyltetracyclo[6.2.1.1^{3,6}.0^{2,7}]dodec-9-ene, 4-methyl-4-propoxycarbonyltetracyclo[6.2.1.1^{3,6}.0^{2,7}]dodec-9-ene, 4-methyl-4-butoxycarbonyltetracyclo[6.2.1.1^{3,6}.0^{2,7}]dodec-9-ene, 4-(2, 2,2-trifluoroethoxycarbonyl)tetracyclo[6.2.1.1^{3,6}.0^{2,7}]dodec-9-ene, 4-methyl-4-(2,2,2-trifluoroethoxycarbonyl)tetracyclo[6.2.1.1^{3,6}.0^{2,7}]dodec-9-ene, etc. may be mentioned.

As the cyclic olefin which has a cyano group, for example, 4-cyanotetracyclo[6.2.1.1^{3,6}.0^{2,7}]dodec-9-ene, 4-methyl-4-cyanotetracyclo[6.2.1.1^{3,6}.0^{2,7}]dodec-9-ene, 4,5-dicyanotetracyclo[6.2.1.1^{3,6}.0^{2,7}]dodec-9-ene, 2-cyanobicyclo[2.2.1]hept-5-ene, 2-methyl-2-cyanobicyclo[2.2.1]hept-5-ene, 2, 3-dicyanobicyclo[2.2.1]hept-5-ene, etc. may be mentioned.

As the cyclic olefin which has an acid anhydride group, for example, tetracyclo[6.2.1.1^{3,6}.0^{2,7}]dodec-9-ene-4,5-dicarboxylic anhydride, bicyclo[2.2.1]hept-5-ene-2,3-dicarboxylic anhydride, 2-carboxymethyl-2-hydroxycarbonylbicyclo[2.2.1]hept-5-ene anhydride, etc. may be mentioned.

As the cyclic olefin which has a halogen atom, for example, 2-chlorobicyclo[2.2.1]hept-5-ene, 2-chloromethylbicyclo[2.2.1]hept-5-ene, 2-(chlorophenyl)bicyclo[2.2.1]hept-5-ene, 4-chlorotetracyclo[6.2.1.1^{3,6}.0^{2,7}]dodec-9-ene, 4-methyl-4-chlorotetracyclo[6.2.1.1^{3,6}.0^{2,7}]dodec-9-ene, etc. may be mentioned.

These monomers (b1) may respectively be used alone or may be used as two types or more combined.

As the cyclic olefin monomer which does not have a polar group (b2), bicyclo[2.2.1]hept-2-ene (also called “norbornene”), 5-ethylbicyclo[2.2.1]hept-2-ene, 5-butyl-bicyclo[2.2.1]hept-2-ene, 5-ethylidene-bicyclo[2.2.1]hept-2-ene, 5-methylidene-bicyclo[2.2.1]hept-2-ene, 5-vinyl-bicyclo[2.2.1]hept-2-ene, tricyclo[5.2.1.0^{2,6}]deca-3, 8-diene (common name: dicyclopentadiene), tetracyclo[10.2.1.0^{2,11}.0^{4,9}]pentadec-4,6,8,13-tetraene, tetracyclo[6.2.1.1^{3,6}.0^{2,7}]dodec-4-ene (also called “tetracyclododecene”), 9-methyl-tetracyclo[6.2.1.1^{3,6}.0^{2,7}]dodec-4-ene, 9-ethyl-tetracyclo[6.2.1.1^{3,6}.0^{2,7}]dodec-4-ene, 9-methylidene-tetracyclo[6.2.1.1^{3,6}.0^{2,7}]dodec-4-ene, 9-ethyl idene-tetracyclo[6.2.1.1^{3,6}.0^{2,7}]dodec-4-ene, 9-vinyl-tetracyclo[6.2.1.1^{3,6}.0^{2,7}]dodec-4-ene, 9-propenyl-tetracyclo[6.2.1.1^{3,6}.0^{2,7}]dodec-4-ene, pentacyclo[9.2.1.1^{3,9}.0^{2,10}.0^{4,8}]pentadeca-5,12-diene, cyclobutene, cyclopentene, cyclopentadiene, cyclohexene, cycloheptene, cyclooctene, cyclooctadiene, indene, 3a,5,6,7a-tetrahydro-4,7-methano-1H-indene, 9-phenyl-tetracyclo[6.2.1.1^{3,6}.0^{2,7}]dodec-4-ene, tetracyclo[9.2.1.0^{2,10}.0^{3,8}]tetradec-3,5,7,12-tetraene, pentacyclo[9.2.1.1^{3,9}.0^{2,10}.0^{4,8}]pentadec-12-ene, etc. may be mentioned. These monomers (b2) may respectively be used alone or may be used as two types or more combined.

As specific examples of the monomer other than a cyclic olefin (b3), ethylene; propylene, 1-butene, 1-pentene, 1-hexene, 3-methyl-1-butene, 3-methyl-1-pentene, 3-ethyl-1-pentene, 4-methyl-1-pentene, 4-methyl-1-hexene, 4,4-dimethyl-1-hexene, 4,4-dimethyl-1-pentene, 4-ethyl-1-hexene, 3-ethyl-1-hexene, 1-octene, 1-decene, 1-dodecene, 1-tetradecene, 1-hexadecene, 1-octadecene, 1-eicosene, and other C₂ to C₂₀ α-olefins; 1,4-hexadiene, 1,5-hexadiene, 4-methyl-1,4-hexadiene, 5-methyl-1,4-hexadiene, 1,7-octadiene, and other nonconjugated dienes and their derivatives; etc. may be mentioned. Among these as well, α-olefin is preferable. These monomers (b3) may respectively be used alone or may be used as two types or more combined.

Among these monomers (b1) to (b3) as well, from the viewpoint of the effect of the present invention becoming more remarkable, a cyclic olefin monomer which has a polar group other than a protonic polar group (b1) is preferable, while a cyclic olefin which has an N-substituted imide group is particularly preferable.

In the cyclic olefin polymer (A), the ratio of content of units of the copolymerizable monomer (b) is preferably 10 to 90 mol % with respect to the total monomer units. If the ratio of content of the units of the copolymerizable monomer (b) is too small, the cyclic olefin polymer (A) is liable to became insufficient in solubility in a polar solvent, while if too great, heat resistance is liable to became insufficient.

Note that, in the present invention, it is also possible to introduce a protonic group in a cyclic olefin-based polymer which does not have a protonic polar group utilizing a known modifying agent so as to obtain the cyclic olefin polymer (A). The polymer which does not have a protonic polar group can be obtained by polymerizing at least one of the above-mentioned monomers (b1) and (b2) and, in accordance with need, a monomer (b3) in any combination.

Note that, the cyclic olefin polymer (A) used in the present invention may be a ring-opened polymer obtained by ring-opening polymerization of the above-mentioned monomers or may be an addition polymer obtained by addition polymerization of the above-mentioned monomers, but from the viewpoint of the effect of the present invention becoming more remarkable, a ring-opened polymer is preferable.

A ring-opened polymer can be produced by ring-opening methathesis polymerization of a cyclic olefin monomer which has a protonic polar group (a) and a copolymerizable monomer (b) used according to need in the presence of a methathesis reaction catalyst. As the method of production, for example, the method described in International Publication No. 2010/110323A, [0039] to [0079], etc. can be used. On the other hand, an addition polymer can be obtained by causing polymerization of a cyclic olefin monomer which has a protonic polar group (a) and a copolymerizable monomer (b) used according to need using a known additional polymerization catalyst, for example, a catalyst comprised of a compound of titanium, zirconium, or vanadium and an organic aluminum compound.

Further, when the cyclic olefin polymer (A) used in the present invention is a ring-opened polymer, it is preferable to further perform a hydrogenation reaction and obtain a hydrogenated product in which the carbon-carbon double bonds which are contained in the main chain are hydrogenated. When the cyclic olefin polymer (A) is a hydrogenated product, the ratio of the hydrogenated carbon-carbon double bonds (hydrogenation rate) is usually 50% or more. From the viewpoint of the heat resistance, 70% or more is preferable, 90% or more is more preferable, and 95% or more is furthermore preferable.

The cyclic olefin polymer (A) used in the present invention has a weight average molecular weight (Mw) of usually 1,000 to 1,000,000, preferably 1,500 to 100,000, more preferably 2,000 to 10,000 in range.

Further, the cyclic olefin polymer (A) has a molecular weight distribution of a weight average molecular weight/number average molecular weight (Mw/Mn) ratio of usually 4 or less, preferably 3 or less, more preferably 2.5 or less.

The weight average molecular weight (Mw) and molecular weight distribution (Mw/Mn) of the cyclic olefin polymer (A) are values which are found by gel permeation chromatography (GPC) using tetrahydrofuran and other solvents as eluents and as values converted to polystyrene.

As the cross-linking agent (B), one which forms a cross-linked structure between cross-linkinag agent molecules due to heating or one which reacts with the cyclic olefin polymer (A) to form a cross-linked structure between resin molecules may be mentioned, specifically, a compound which has two or more reactive groups may be mentioned. As such a reactive group, for example, an amino group, carboxy group, hydroxyl group, epoxy group, or isocyanate group may be mentioned. More preferably, it is an amino group, epoxy group, or isocyanate group. An amino group or epoxy group is particularly preferable.

The molecular weight of the cross-linking agent (B) is not particularly limited, but is usually 100 to 100,000, preferably 300 to 50,000, more preferably 500 to 10,000. The cross-linking agent (B) may be used as single type alone or as two types or more combined.

As specific examples of the cross-linking agent (B), hexamethylenediamine and other aliphatic polyamines; 4,4′-diaminodiphenyl ether, diaminodiphenyl sulfone, and other aromatic polyamines; 2,6-bis(4′-azidebenzal)cyclohexanone, 4,4′-diazidediphenyl sulfone, and other azides; nylon, polyhexamethylenediamine terephthalamide, polyhexamethyleneisophthalamide, and other polyamides; N,N,N′,N′,N″,N″-(hexaalkoxyalkyl)melamine, and other melamines which may have a methylol group, imino group, etc. (product name “Cymel 303, Cymel 325, Cymel 370, Cymel 232, Cymel 235, Cymel 272, Cymel 212, Mycoat 506” (above, made by Cytec Industries) and other Cymel series and Mycoat series products); N,N′,N″,N″′-(tetraalkoxyalkyl)glycoluril, and other glycolurils which may have a methylol group, imino group etc. (product name “Cymel 1170” (above, made by Cytec Industries) and other Cymel series products); ethylene glycol di(meth)acrylate and other acrylate compounds; hexamethylene diisocyanate-based polyisocyanate, isophorone diisocyanate-based polyisocyanate, tolylene diisocyanate-based polyisocyanate, hydrated diphenylmethane diisocyanate, and other isocyanate-based compounds; 1,4-di-(hydroxymethyl)cyclohexane, 1,4-di-(hydroxymethyl) norbornane; 1,3,4-trihydroxycyclohexane; bisphenol A-type epoxy resin, bisphenol F-type epoxy resin, phenol novolac-type epoxy resin, cresol novolac-type epoxy resin, polyphenol-type epoxy resin, cyclic aliphatic epoxy resin, aliphatic glycidyl ether, epoxy acrylate polymer, and other epoxy compounds; may be mentioned.

Further, as specific examples of the epoxy compound, a trifunctional epoxy compound which has a dicyclopentadiene structure (product name “XD-1000”, made by Nippon Kayaku), a 1,2-epoxy-4-(2-oxiranyl)cyclohexane adduct of 2,2-bis(hydroxymethyl)1-butanol (pentadecafunctional alicyclic epoxy resin having a cyclohexane structure and end epoxy groups, product name “EHPE3150”, made by Daicel Chemical Industry), epoxylated 3-cyclohexene-1,2-dicarboxylic acid bis(3-cyclohexenylmethyl) modified ε-caprolactone (aliphatic cyclic trifunctional epoxy resin, product name “Epolide GT301”, made by Daicel Chemical Industry), epoxylated butanetetracarboxylic acid tetrakis(3-cyclohexenylmethyl) modified ε-caprolactone (aliphatic cyclic tetrafunctional epoxy resin, product name “Epolide GT401”, made by Daicel Chemical Industry), and other epoxy compounds having alicyclic structures;

aromatic amine-type polyfunctional epoxy compound (product name “H-434”, made by Tohto Chemical Industry), cresol novolac-type polyfunctional epoxy compound (product name “EOCN-1020”, made by Nippon Kayaku), phenol novolac-type polyfunctional epoxy compound (Epicoat 152, 154, made by Japan Epoxy Resin), polyfunctional epoxy compound having a naphthalene structure (product name EXA-4700, made by DIC), chain alkylpolyfunctional epoxy compound (product name “SR-TMP”, made by Sakamoto Yakuhin Kogyo Co., Ltd.), polyfunctional epoxy polybutadiene (product name “Epolide PB3600”, made by Daicel Chemical Industry), glycidyl polyether compound of glycerin (product name “SR-GLG”, made by Sakamoto Yakuhin Kogyo Co., Ltd.), diglycerin polyglycidyl ether compound (product name “SR-DGE”, made by Sakamoto Yakuhin Kogyo Co., Ltd.), polyglycerin polyglycidyl ether compound (product name “SR-4GL”, made by Sakamoto Yakuhin Kogyo Co., Ltd.), and other epoxy compounds not having an alicyclic structure; may be mentioned.

In the resin composition used in the present invention, the content of the cross-linking agent (B) is preferably 5 to 40 parts by weight with respect to 100 parts by weight of the cyclic olefin polymer (A), more preferably 7 to 35 parts by weight, furthermore preferably 10 to 30 parts by weight, particularly preferably 10 to 25 parts by weight. If the content of the cross-linking agent (B) is too small, heat resistance is liable to deteriorate. On the other hand, if the content of the cross-linking agent (B) is too great, the adhesion between the obtained resin film and base film ends up falling.

The (meth)acrylate compound (C) is not particularly limited so long as an ester of a (meth)acrylic acid (meaning acrylic acid and/or methacrylic acid, same below), but, for example, an alkoxysilyl-group containing (meth)acrylate compound, epoxy-group containing (meth)acrylate compound, and tetrafunctional or higher functional (meth)acrylate compound etc. can be preferably used. The (meth)acrylate compound (C) is a compound acting as a cross-linking aid. By acting as a cross-linking aid, the (meth)acrylate compound (C) contributes the improvement of the adhesion between the obtained resin film and the base film.

As specific examples of the alkoxysilyl-group containing (meth)acrylate compound, 2-acryloxyethyltrimethoxysilane, 2-acryloxyethyltriethoxysilane, 3-acryloxypropyltrimethoxysilane, 3-acryloxypropylmethyldimethoxysilane, 3-acryloxypropyltriethoxysilane, 4-acryloxybutyltrimethoxysilane, 4-acryloxybutyltriethoxysilane, 2-methacryloxyethyltrimethoxysilane, 2-methacryloxyethyltriethoxysilane, 3-methacryloxypropyltrimethoxysilane, 3-methacryloxypropylmethyldimethoxysilane, 3-methacryloxypropyltriethoxysilane, 3-methacryloxymethyldiethoxysilane, 4-methacryloxybutyltrimethoxysilane, 4-methacryloxybutyltriethoxysilane, etc. may be mentioned. These may be used as single type alone or as two or more types combined.

As specific examples of the epoxy-group containing (meth)acrylate compound, glycidyl acrylate, glycidyl methacrylate, glycidyl α-ethylacrylate, glycidyl α-n-propylacrylate, glycidyl α-n-butylacrylate, 3,4-epoxybutyl acrylate, 3,4-epoxybutyl methacrylate, 6,7-epoxyheptyl acrylate, 6,7-epoxyheptyl methacrylate, 6,7-epoxyheptyl α-ethylacrylate, 3,4-epoxycyclohexylmethyl acrylate, 3,4-epoxycyclohexylmethyl methacrylate (for example, product name “Cyclomer M100”, made by Daicel), 4-glycidyloxy-3,5-dimethylbenzyl acrylate, 4-glycidyloxy-3,5-dimethylbenzyl methacrylate, etc. may be mentioned. These may be used as single type alone or as two or more types combined.

As specific examples of the tetrafunctional or higher functional (meth)acrylate compound, dipentaerythritol hexaacrylate (for example, product name “DPHA”, made by Daicel-Cytec, product name “Light Acrylate DPE-6A”, made by Kyoei Kagaku, or product name “A-DPH”, made by Shin-Nakamura Chemical), pentaerythritolethoxy tetraacrylate (for example, product name “EBECRYL40”, made by Daicel-Cytec), di-trimethylolpropane tetraacrylate (for example, product name “AD-TMP”, made by Shin-Nakamura Chemical), ethoxylated pentaerythritol tetraacrylate (for example, product name “ATM-35E”, made by Shin-Nakamura Chemical), pentaerythritol tetraacrylate (for example, product name “A-TMMT”, made by Shin-Nakamura Chemical), di-pentaerythritol polyacrylate (for example, product name “A-9550”, made by Shin-Nakamura Chemical), pentaerythritol tri/tetraacrylate (for example, product name “Aronix M-303 Tri 40-60%”, product name “Aronix M-305 Tri 55-63%”, or product name “Aronix M-306 Tri 65-70%”, all made by Toagosei), dipentaerythritol penta/hexaacrylate (for example, product name “Aronix M-402 Penta 30-40%” or product name “Aronix M-406 Penta 25-35%”, all made by Toagosei), di-trimethylolpropane tetraacrylate (for example, product name “Aronix M-408”, made by Toagosei), polybasic acid-modified acryl oligomer (for example, product name “Aronix M-510”, made by Toagosei) etc. may be mentioned. These may be used as single type alone or as two or more types combined.

In the resin composition used in the present invention, the content of the (meth)acrylate compound (C) is preferably 0.5 to 10 parts by weight with respect to 100 parts by weight of the cyclic olefin polymer (A), more preferably 0.7 to 7 parts by weight, furthermore preferably 1 to 5 parts by weight. If the content of the (meth)acrylate compound (C) is too small, the chemical resistance ends up becoming poor. On the other hand, if the content of the (meth)acrylate compound (C) is too large, the adhesion between the obtained resin film and base film ends up falling.

The radical generator (D) is not particularly limited so long as a compound generating radicals due to heat or light. As specific examples of the radical generator (D), benzophenone, methyl o-benzoyl benzoate, 4,4-bis(dimethylamine) benzophenone, 4,4-bis(diethylamine)benzophenone, α-amino-acetophenone, 4,4-dichlorobenzophenone, 4-benzoyl-4-methyldiphenylketone, dibenzylketone, fluorene, 2,2-diethoxyacetophenone, 2,2-dimethoxy-2-phenylacetophenone, 2-hydroxy-2-methylpropiophenone, p-tert-butyldichloroacetophenone, thioxantone, 2-methylthioxantone, 2-chlorothioxantone, 2-isopropylthioxantone, diethylthioxantone, benzyldimethylketal, benzylmethoxyethylacetal, benzoinmethyl ether, benzoinbutyl ether, anthraquinone, 2-tert-butylanthraquinone, 2-amylbutylanthraquinone, β-chloroanthraquinone, anthrone, benzanthrone, dibenzsuberon, methylene anthrone, 4-acidobenzylacetophenone, 2,6-bis(p-azidebenzylidene)cyclohexane, 2,6-bis(p-azidebenzylidene)-4-methylcyclohexanone, 2-phenyl-1,2-butadione-2-(o-methoxycarbonyl)oxime, 1-phenyl-propanedion-2-(o-ethoxycarbonyl)oxime, 1,3-diphenyl-propanetrione-2-(o-ethoxycarbonyl)oxime, 1-phenyl-3-ethoxy-propanetrione-2-(o-benzoyl)oxime, Michler's ketone, 2-methyl-1[4-(methylthio)phenyl]-2-morpholinopropan-1-one, 2-benzyl-2-dimethylamino-1-(4-morpholinophenyl)-butanone, naphthalenesulfonyl chloride, quinolinesulfonyl chloride, n-phenylthioacrylidone, 4,4-azobisisobutyronitrile, diphenyl disulfide, benzothiazole disulfide, triphenylphosphine, camphorquinone, N,N-octamethylenebisacridine, 2-(dimethylamino)-2-[(4-methylphenyl)methyl]-1-[4-(4-morpholinyl)phenyl]-1-butanone (product name “Irgacure 379EG”, made by BASF), 1-hydroxy-cyclohexyl-phenyl-ketone (product name “IRGACURE 184”, made by BASF), 2-hydroxy-1-{4-[4-(2-hydroxy-2-methyl-propionyl)-benzyl]phenyl}-2-methyl propan-1-one (product name “IRGACURE 127”, made by BASF), 2-methyl-1-(4-methylthiophenyl)-2-morpholinopropan-1-one (product name “IRGACURE 907”, made by BASF), 1,7-bis(9-acridyl)-heptane (made by ADEKA, N1717), 1,2-octanedion, 1-[4-(phenylthio)-,2-(o-benzoyloxime)] (made by BASF, OXE-01), ethanone, 1-[9-ethyl-6-(2-methylbenzoyl)-9H-carbazol-3-yl]-,1-(o-acetylox ime) (made by BASF, OXE-02), carbon tetrachloride, tribromophenylsulfone, benzoin peroxide, eosin, methylene blue, and other photoreducing dyes and ascorbic acid or triethanolamine and other reducing agents in combination etc. may be mentioned. These may be used as single type alone or as two types or more combined.

In the resin composition used in the present invention, the content of the radical generator (D) is preferably 0.3 to 8 parts by weight with respect to 100 parts by weight of the cyclic olefin polymer (A), more preferably 0.5 to 6 parts by weight, furthermore preferably 0.7 to 4 parts by weight. By making the content of the radical generator (D) in this range, it is possible to make the adhesion between the obtained resin film and the base film better.

As the antioxidant (E), ones which are used for usual polymers such as a phenol-based antioxidant, phosphorus-based antioxidant, sulfur-based antioxidant, lactone-based antioxidant, etc. may be used. Among these as well, a phenol-based antioxidant is preferable.

As the phenol-based antioxidant, for example, 2-t-butyl-6-(3-t-butyl-2-hydroxy-5-methylbenzyl)-4-methylphenylacrylate, 2,4-di-t-amyl-6-[1-(3,5-di-t-amyl-2-hydroxyphenyl)ethyl]phenylacrylate, and other acrylate-based compounds; 2,6-di-t-butyl-4-methylphenol, 2,6-di-t-butyl-4-ethylphenol, octadecyl-3-(3,5-di-t-butyl-4-hydroxyphenyl)propionate, 2,2′-methylene-bis(4-methyl-6-t-butylphenol), 4,4′-butylidene-bis(6-t-butyl-m-cresol), 4,4′-thiobis(3-methyl-6-t-butylphenol), bis(3-cyclohexyl-2-hydroxy-5-methylphenyl)methane, 3, 9-bis[2-[3-(3-t-butyl-4-hydroxy-5-methylphenyl)propionyloxy]-1,1-dimet hylethyl]-2,4,8,10-tetraoxaspiro[5,5]undecane, 1,1,3-tris(2-methyl-4-hydroxy-5-t-butylphenyl)butane, 1,3,5-trimethyl-2,4,6-tris(3,5-di-t-butyl-4-hydroxybenzyl)benzene, pentaerythritoltetrakis[3-(3,5-di-t-butyl-4-hydroxyphenyl)propionate], triethyleneglycol bis[3-(3-t-butyl-4-hydroxy-5-methylphenyl)propionate], tocopherol, and other alkyl-substituted phenol-based compounds; 6-(4-hydroxy-3,5-di-t-butylanilino)-2,4-bis-octylthio-1,3,5-triazine, 6-(4-hydroxy-3,5-dimethylanilino)-2,4-bis-octylthio-1,3,5-triazine, 6-(4-hydroxy-3-methyl-5-t-butylanilino)-2,4-bis-octylthio-1,3,5-triazine, 2-octylthio-4,6-bis-(3,5-di-t-butyl-4-oxyanilino)-1,3,5-triazine, and other triazine-group containing phenol-based compounds; etc. may be mentioned.

As the phosphorus-based antioxidant, for example, triphenyl phosphite, diphenylisodecyl phosphite, phenyldiisodecyl phosphite, tris(nonylphenyl) phosphite, tris(dinonylphenyl) phosphite, tris(2,4-di-t-butylphenyl) phosphite, tris(2-t-butyl-4-methylphenyl) phosphite, tris(cyclohexylphenyl) phosphite, 2,2′-methylene bis(4,6-di-t-butylphenyl)octyl phosphite, 9,10-dihydro-9-oxa-10-phosphaphenanthren-10-oxide, 10-(3,5-di-t-butyl-4-hydroxybenzyl)-9, 10-dihydro-9-oxa-10-phosphaphenant hrene-10-oxide, 10-desiloxy-9,10-dihydro-9-oxa-10-phosphaphenanthrene, and other monophosphite-based compounds; 4,4′-butylidene-bis(3-methyl-6-t-butylphenyl-di-tridecylphosphite), 4,4′-isopropylidene-bis[phenyl-di-alkyl (C₁₂ to C₁₅)phosphite], 4,4′-isopropylidene-bis[diphenylmonoalkyl (C₁₂ to C₁₅)phosphite], 1,1,3-tris(2-methyl-4-di-tridecylphosphite-5-t-butylphenyl)butane, tetrakis(2,4-di-t-butylphenyl)-4,4′-biphenylene diphosphite, cyclic neopentanetetraylbis(octadecylphosphite), cyclic neopentanetetraylbis(isodecylphosphite), cyclic neopentanetetraylbis(nonylphenylphosphite), cyclic neopentanetetraylbis(2,4-di-t-butylphenylphosphite), cyclic neopentanetetraylbis(2,4-dimethylphenylphosphite), cyclic neopentanetetraylbis(2,6-di-t-butylphenylphosphite), and other diphosphite-based compounds; etc. may be mentioned.

As the sulfur-based antioxidant, for example, dilauryl 3,3′-thiodipropionate, dimyristyl 3,3′-thiodipropionate, distearyl 3,3′-thiodipropionate, laurylstearyl 3,3′-thiodipropionate, pentaerythritol-tetrakis-(β-lauryl-thiopropionate), 3,9-bis(2-dodecylthioethyl)-2,4,8,10-tetraoxaspiro[5,5]undecane, etc. may be mentioned.

These antioxidants (E) may be used as single type alone or as two or more types combined. In the resin composition used in the present invention, the content of the antioxidant (E) is not particularly limited, but is preferably 0.1 to 20 parts by weight with respect to 100 parts by weight of the cyclic olefin polymer (A), more preferably 0.5 to 10 parts by weight, furthermore preferably 1 to 5 parts by weight. By making the content of the antioxidant (E) in the above range, the transparency after curing can be improved.

Further, the resin composition used in the present invention may further contain a solvent in addition to a cyclic olefin polymer (A), cross-linking agent (B), (meth)acrylate compound (C), radical generator (D), and antioxidant (E). The solvent is not particularly limited, but one known as a solvent of a resin composition, for example, acetone, methylethylketone, cyclopentanone, 2-hexanone, 3-hexanone, 2-heptanone, 3-heptanone, 4-heptanone, 2-octanone, 3-octanone, 4-octanone, or other straight chain ketones; n-propyl alcohol, isopropyl alcohol, n-butyl alcohol, cyclohexanol, or other alcohols; ethyleneglycol dimethyl ether, ethyleneglycol diethyl ether, dioxane, or other ethers; ethyleneglycol monomethyl ether, ethyleneglycol monoethyl ether, or other alcohol ethers; propyl formate, butyl formate, propyl acetate, butyl acetate, methyl propionate, ethyl propionate, methyl butyrate, ethyl butyrate, methyl lactate, ethyl lactate, or other esters; cellosolve acetate, methylcellosolve acetate, ethylcellosolve acetate, propylcellosolve acetate, butylcellosolve acetate, or other cellosolve esters; propyleneglycol, propyleneglycol monomethyl ether, propylene glycol monomethyl ether acetate, propylene glycol monoethyl ether acetate, propylene glycol monobutyl ether, or other propylene glycols; diethylene glycol monomethyl ether, diethylene glycol monoethyl ether, diethylene glycol dimethyl ether, diethylene glycol diethyl ether, diethylene glycol methylethyl ether, or other diethylene glycols; γ-butyrolactone, γ-valerolactone, γ-caprolactone, γ-caprylolactone, or other saturated γ-lactones; trichloroethylene or other halogenated hydrocarbons; toluene, xylene, or other aromatic hydrocarbons; dimethylacetoamide, dimethylformamide, N-methylacetoamide, or other polar solvents; etc. may be mentioned. These solvents may be used alone or as two types or more combined. Note that, when the resin composition is made to include a solvent, the solvent is normally removed after forming the resin film.

Furthermore, the resin composition used in the present invention may contain, as desired, a surfactant, acidic compound, coupling agent or its derivative, sensitizer, latent acid generator, photostabilizer, defoamer, pigment, dye, filler, and other compounding agents etc. so long as in a range where the effects of the present invention are not impaired.

The surfactant is used to prevent striation, improve the development property, and for other purposes. As specific examples of the surfactant, polyoxyethylene lauryl ether, polyoxyethylene stearyl ether, polyoxyethylene oleyl ether, and other polyoxyethylene alkyl ethers; polyoxyethylene octylphenyl ether, polyoxyethylene nonyl phenyl ether, and other polyoxyethylene aryl ethers; polyoxyethylene dilaurate, polyoxyethylene distearate, and other polyoxyethylene dialkyl esters, and other nonion-based surfactants; fluorine-based surfactants; silicone-based surfactants; methacrylic acid copolymer-based surfactants; acrylic acid copolymer-based surfactants; etc. may be mentioned.

The coupling agent or its derivative has the effect of further improving the adhesion between the resin film comprised of the resin composition and the base film. As the coupling agent or its derivative, a compound which has one atom selected from a silicon atom, titanium atom, aluminum atom, and zirconium atom and has a hydrocarbyloxy group or hydroxyl group which bonds with that atom can be used.

As the coupling agent or its derivative, for example, tetramethoxysilane, tetraethoxysilane, tetra-n-propoxysilane, tetra-i-propoxysilane, tetra-n-butoxysilane, and other tetraalkoxysilanes,

methyltrimethoxysilane, methyltriethoxysilane, ethyltrimethoxysilane, ethyltriethoxysilane, n-propyltrimethoxysilane, n-propyltriethoxysilane, i-propyltrimethoxysilane, i-propyltriethoxysilane, n-butyltrimethoxysilane, n-butyltriethoxysilane, n-pentyltrimethoxysilane, n-hexyltrimethoxysilane, n-heptyltrimethoxysilane, n-octyltrimethoxysilane, n-decyltrimethoxysilane, p-styryltrimethoxysilane, vinyltrimethoxysilane, vinyltriethoxysilane, cyclohexyltrimethoxysilane, cyclohexyltrimethoxysilane, cyclohexyltriethoxysilane, phenyltrimethoxysilane, phenyltriethoxysilane, 3-chloropropyltrimethoxysilane, 3-chloropropyltriethoxysilane, 3,3,3-trifluoropropyltrimethoxysilane, 3,3,3-trifluoropropyltriethoxysilane, 3-aminopropyltrimethoxysilane, 3-aminopropyltriethoxysilane, N-2-(aminoethyl)-3-aminopropyltrimethoxysilane, N-phenyl-3-aminopropyltrimethoxysilane, 2-hydroxyethyltrimethoxysilane, 2-hydroxyethyltriethoxysilane, 2-hydroxypropyltrimethoxysilane, 2-hydroxypropyltriethoxysilane, 3-hydroxypropyltrimethoxysilane, 3-hydroxypropyltriethoxysilane, 3-mercaptopropyltrimethoxysilane, 3-mercaptopropyltriethoxysilane, 3-isocyanate propyltrimethoxysilane, 3-isocyanate propyltriethoxysilane, 3-glycidoxypropyltrimethoxysilane, 3-glycidoxypropyltriethoxysilane, 2-(3,4-epoxycyclohexyl)ethyltrimethoxysilane, 2-(3,4-epoxycyclohexyl)ethyltriethoxysilane, 3-(meth)acryloxypropyltrimethoxysilane, 3-(meth)acryloxypropyltriethoxysilane, 3-ureidopropyltrimethoxysilane, 3-ureidopropyltriethoxysilane, 3-ethyl(trimethoxysilylpropoxymethyl)oxetane, 3-ethyl(triethoxysilylpropoxmthyl)oxetane, 3-triethoxysilyl-N-(1,3-dimethyl-butylidene)propylamine, bis(triethoxysilylpropyl)tetrasulfide, and other trialkoxysilanes,

dimethyldimethoxysilane, dimethyldiethoxysilane, diethyldimethoxysilane, diethyldiethoxysilane, di-n-propyldimethoxysilane, di-n-propyldiethoxysilane, di-i-propyldimethoxysilane, di-i-propyldiethoxysilane, di-n-butyldimethoxysilane, di-n-pentyldimethoxysilane, di-n-pentyldiethoxysilane, di-n-hexyldimethoxysilane, di-n-hexyldiethoxysilane, di-n-heptyldimethoxysilane, di-n-heptyldiethoxysilane, di-n-octyldimethoxysilane, di-n-octyldiethoxysilane, di-n-cyclohexyldimethoxysilane, di-n-cyclohexyldiethoxysilane, diphenyldimethoxysilane, diphenyldiethoxysilane, 3-glycidoxypropylmethyldiethoxysilane, 3-methacryloxypropylmethyldimethoxysilane, 3-acryloxypropylmethyldimethoxysilane, 3-methacryloxypropylmethyldiethoxysilane, 3-acryloxypropylmethyldiethoxysilane, N-2-(aminoethyl)-3-aminopropylmethyldimethoxysilane, and other dialkoxysilanes, and

methyl triacetyloxysilane, dimethyl diacetyloxysilane, and other silicon atom-containing compounds;

titanium tetra-i-propoxide, titanium tetra-n-butoxide, titanium tetrakis(2-ethylhexyloxide), titanium i-propoxyoctyleneglycolate, titanium di-i-propoxy-bis(acetylacetonate), propane dioxytitanium bis(ethylacetoacetate), tri-n-butoxytitanium monostearate, di-i-propoxytitanium distearate, titanium stearate, di-i-propoxytitanium diisostearate, titanium (2-n-butoxycarbonylbenzoyloxy)tributoxide, di-n-butoxy-bis(triethanolaminate) titanium, and the Plenacto series (made by Ajinomoto Fine Techno) and other titanium-atom containing compounds;

acetoalkoxyaluminum diisopropylate, and other aluminum-atom containing compounds;

zirconium tetra-n-propoxide, zirconium tetra-n-butoxide, zirconium tetraacetyl acetonate, zirconium tributoxyacetyl acetonate, zirconium monobutoxyacetyl acetonate bis(ethylacetoacetate), zirconium dibutoxybis(ethylacetoacetate), zirconium tetraacetyl acetonate, zirconium tributoxy stearate and other zirconium-atom containing compounds may be mentioned.

As specific examples of a sensitizer, 2H-pyrido-(3,2-b)-1,4-oxazin-3(4H)-ones, 10H-pyrido-(3,2-b)-1,4-benzothiazines, urazoles, hidantoins, barbituric acid, glycerin anhydrides, 1-hydroxybenzotriazoles, alloxans, maleimides, etc. may be mentioned.

As the photostabilizer, any of a benzophenone-based, salicylic acid ester-based, benzotriazole-based, cyanoacrylate-based, metal complex-based, and other ultraviolet absorbers, hindered amine light stabilizes (HALS), and other ones which trap radicals generated due to light may be used. Among these as well, a HALS is a compound having a piperidine structure which is low in coloring of resin compositions and is good in stability, so is preferable. As specific compounds, a bis(2,2,6,6-tetramethyl-4-piperidyl)sebacate, 1,2,2,6,6-pentamethyl-4-piperidyl/tridecyl-1,2,3,4-butanetetracarboxylat e, bis(1-octyloxy-2,2,6,6-tetramethyl-4-piperidyl)sebacate, etc. may be mentioned.

The method of preparation of a resin composition used in the present invention is not particularly limited. The components which form the resin composition may be mixed by a known method.

The method of mixing is not particularly limited, but it is preferable to dissolve or disperse the components which form the resin composition in solvents and mix the solutions or dispersions. Due to this, the resin composition is obtained in the form of a solution or dispersion.

The method of dissolving or dispersing the components which form the resin composition in solvents may be an ordinary method. Specifically, this may be performed by stirring using a stirring bar and magnetic stirrer, high speed homogenizer, disperser, planetary stirrer, twin-screw stirrer, ball mill, triple roll, etc. Further, the ingredients may also be dissolved or dispersed in a solvent, then for example filtered using a filter with a pore size of 0.5 μm or so etc.

(Laminate)

Next, the laminate of the present invention will be explained. The laminate of the present invention is a laminate obtained by forming a resin film on a base film with a glass transition temperature of 60 to 160° C., wherein the resin film is formed using the above resin composition.

The base film with a glass transition temperature of 60 to 160° C. used in the present invention (below, simply referred to as a “base film”) is not particularly limited, but, for example, when using the laminate of the present invention for the application of a protective board of a flexible organic EL display, one having flexibility and transparency is preferable.

The base film used in the present invention is not particularly limited, but, for example, a cyclic polyolefin-based resin, polystyrene-based resin, acrylonitrile-styrene copolymer (AS resin), acrylonitrile-butadiene-styrene copolymer (ABS resin), poly(meth)acrylic-based resin, polycarbonate-based resin, polyethylene terephthalate, polyethylene naphthalate, and other polyester-based resins, various types of nylon and other polyamide-based resins, a polyurethane-based resin, fluorine-based resin, acetal-based resin, cellulose-based resin, polyether sulfone-based resin, etc. may be mentioned. Among these as well, from the viewpoint of being excellent in transparency, a polyester-based resin is preferable while polyethylene terephthalate and polyethylene naphthalate are more preferable, while from the viewpoint of being excellent in heat resistance, polyethylene naphthalate is more preferable.

Further, when measuring the transmittance for a wavelength of 400 to 700 nm in range, the base film used in the present invention has a total transmittance in a range of 400 to 700 nm is preferably 90% or more, more preferably 95% or more.

The thickness of the base film used in the present invention is not particularly limited, but is preferably 10 to 500 μm, more preferably 50 to 400 μm, furthermore preferably 100 to 300 μm. If the base film is too thick, when applied to the application of a protective board of a flexible organic EL display, the flexibility will end up becoming too low. Further, if too thin, the gas barrier property of the laminate is liable to fall.

Further, the laminate of the present invention can be produced by forming a resin film on such a base film using the above-mentioned resin composition.

The method of forming a resin film on a base film is not particularly limited, but, for example, the coating method, film lamination method or other method can be used.

The coating method is, for example, the method of coating a resin composition, then drying by heating to remove the solvent. As the method of coating the resin composition, for example, the spray method, spin coat method, roll coat method, die coat method, doctor blade method, spin coat method, bar coat method, screen print method, and other various methods can be employed. The heating and drying conditions differ according to the type and ratio of the ingredients, but are usually 30 to 150° C., preferably 60 to 120° C. usually for 0.5 to 90 minutes, preferably 1 to 60 minutes, more preferably 1 to 30 minutes.

The film lamination method is a method comprising coating a resin composition on a resin film separate from the base film-forming part of the laminate of the present invention, metal film or other substrate for forming B-stage film, then heating and drying it to remove the solvent to obtain the B-stage film, then laminating this B-stage film. The heating and drying conditions may be suitably selected in accordance with the types and ratios of content of the ingredients, but the heating temperature is usually 30 to 150° C. and the heating time is usually 0.5 to 90 minutes. The film lamination may be performed by using a press laminator, press, vacuum laminator, vacuum press, roll laminator, and other press bonding machines.

The thickness of the resin film is not particularly limited and may be suitably set in accordance with the application, but when the resin film is, for example, a flattening film of a protective board of a flexible organic EL display, the thickness of the resin film is preferably 0.1 to 100 μm, more preferably 0.5 to 50 nm, furthermore preferably 0.5 to 30 μm.

Next, the resin film is formed on the base film, then the formed resin film is made to react for cross-linking. The method of this cross-linking may be suitably selected in accordance with the type of the cross-linking agent (B) included in the above-mentioned resin composition, but is usually heating. The heating method, for example, may be one using a hot plate, oven, etc. The heating temperature is usually 180 to 250° C. The heating time is suitably selected in accordance with the area or thickness of the resin film, the equipment which is used, etc. For example, when using a hot plate, it is normally 5 to 60 minutes, while when using an oven, it is normally 30 to 90 minutes. The heating may be performed in accordance with need in an inert gas atmosphere. The inert gas may be one which does not contain oxygen and which does not oxidize a resin film. For example, nitrogen, argon, helium, neon, xenon, krypton, etc. may be mentioned. Among these as well, nitrogen and argon are preferable. In particular, nitrogen is preferable. In particular, inert gas with an oxygen content of 0.1 vol % or less, preferably 0.01 vol % or less, in particular nitrogen, is suitable. These inert gases may be respectively used alone or as two types or more combined.

Note that, when making the laminate of the present invention a protective board of a flexible organic EL display, a color filter may be provided in a manner enclosed inside the above-mentioned resin film to give the laminate the function as a color filter.

When forming a color filter layer, the color filter layer and the resin film may be formed by the following method. That is, first, by using a method similar to the above, the above-mentioned resin composition is used to form a first resin film on a base film by coating method, film lamination method, or other methods. Further, this first resin film was formed with a layer comprised of a resin material containing pigments corresponding to the different colors for forming a color filter layer by the printing method etc. in a predetermined pattern. Next, on this, by using a method similar to the above, the above-mentioned resin composition is used to form a second resin film by coating method, film lamination method, or other methods. Further, the same procedure was followed as above to make the first resin film and second resin film react to cross-link and thereby form a resin film enclosing a color filter layer.

Further, in the present invention, the resin film of the thus obtained laminate of the present invention may be further formed with an inorganic film. By forming an inorganic film on the resin film, the gas barrier property of the obtained laminate can be further improved. Such an inorganic film formed on a resin film is not particularly limited so long as a film comprised of inorganic materials, but a transparent inorganic oxide film, transparent inorganic oxynitride film, transparent inorganic nitride film, or metal film is preferable.

As the transparent inorganic film, a silicon oxide film, silicon oxynitride film, aluminum oxide film, magnesium oxide film, titanium oxide film, stannous oxide film, indium oxide alloy film, etc. may be mentioned. Further, as the transparent inorganic nitride film, a silicon nitride film, aluminum nitride film, titanium nitride film, etc. may be mentioned. Furthermore, as the transparent metal film, an aluminum film, silver film, tin film, chromium film, nickel film, titanium film, etc. may be mentioned. Among these as well, from the viewpoint of being able to impart an excellent gas barrier property to the obtained laminate, a transparent inorganic nitride film is preferable and a silicon nitride film is more preferable.

The method of forming an inorganic film on a resin film is not particularly limited, but the vapor deposition method may be used. As the vapor deposition method, for example, the vacuum vapor deposition method of heating an inorganic oxide, inorganic nitride, inorganic oxynitride, metal, etc. and depositing it on a base material as a vapor; an oxidation reaction vapor deposition method of using an inorganic oxide, inorganic nitride, inorganic oxynitride, or metal as a starting material and introducing oxygen gas for oxidation to cause vapor deposition on the base material; a sputtering method of using an inorganic oxide, inorganic nitride, inorganic oxynitride, or metal as a target starting material and introducing argon gas or oxygen gas for sputtering to cause vapor deposition on the base material; an ion plating method of causing heating of an inorganic oxide, inorganic nitride, inorganic oxynitride, or metal by a plasma beam generated by a plasma gun to cause vapor deposition on the base material; the plasma CVD method of using an organic silicon compound as a starting material when forming a vapor deposited film of silicon oxide; etc. may be mentioned. Among these as well, from the viewpoint of the denseness of the produced film, the plasma CVD method is preferably used.

The thickness of the inorganic film is not particularly limited and is suitably selected by the material forming the inorganic film, but is preferably 5 nm to 5000 nm, more preferably 5 nm to 500 nm. If the thickness of the inorganic film is too small, sometimes the effect of improvement of the gas barrier property ends up becoming insufficient. On the other hand, if too thick, at the time of processing etc., cracks etc. are liable to form and, further, the obtained laminate is liable to fall in transparency.

The thus obtained laminate of the present invention is excellent in interlayer adhesion and excellent in flatness and transparency, so it is possible to utilize these characteristics so as to particularly preferably use it as a protective board for a flexible organic EL display. In particular, the laminate of the present invention is excellent in interlayer adhesion, when the resin film formed at a baking temperature (curing temperature) of 180° C. or more is tested by a cross-cut test based on JIS K5400-8.5, it is class 0 (no peeling at all and residual ratio of resin film of 100%). For this reason, the laminate of the present invention is excellent in interlayer adhesion and flatness when used as a protective board for a flexible organic EL display, so can exhibit an excellent gas barrier property. Due to this, it is possible to raise the reliability of a flexible organic EL display.

### EXAMPLES

Below, examples and comparative examples will be given to more specifically explain the present invention. In the examples, “parts” are based on weight unless particularly indicated otherwise.

Note that, the definitions and methods of evaluation of the different characteristics are as follows.

<Adhesion of Resin Film and Film (Cross-Cut Test)>

A substrate obtained by bonding a PEN film (polyethylene naphthalate film) on glass was washed by UV/O by 2000 mJ/cm², then was washed by 5 minutes using ultrasonic cleaning two times. Further, the PEN film of the substrate was coated by a resin composition by the spin coat method and prebaked using a hot plate under conditions of 100° C. for 2 minutes, then was cured using an oven in the air atmosphere under conditions of 180° C. for 3 hours to form a thickness 2 μm resin film on the PEN film of the substrate.

Further, the thus formed resin film was subjected to a cross-cut test based on JIS K5400-8.5. Specifically, first, a cutter knife was used to cut a 10×10=100 grid in the formed resin film. Further, cellophane tape was strongly pressed against the grid part, the end of the cellophane tape was peeled off all at once at a 45° angle, the residual ratio of the resin film (ratio of resin film remaining on substrate) was found, and the following criteria was used to evaluate the adhesion.
A: Residual ratio of resin film:100% (class 0)
B: Residual ratio of resin film:80% to less than 100%
C: Residual ratio of resin film:less than 80%

Note that, Examples 2 and 4 were evaluated not only for substrates on which PEN films were formed but also substrates on which PET films (polyethylene terephthalate films) were formed. Note that, in the evaluation using PET films, except for changing the curing temperature from 180° C. to 130° C., the same procedure as the evaluation using PEN films was followed to evaluate them.

(Flatness)

A nonalkali glass substrate was coated with a resin composition by the spin coating method, a hot plate was used to prebake this under conditions of 100° C. and 2 minutes, then an oven was used to cure this in an air atmosphere under conditions of 180° C. for 3 hours to thereby form a thickness 2 μm resin film. Further, the surface of the obtained resin film was measured for arithmetic surface roughness Ra using a nanoscale hybrid microscope (made by Keyence, “Nanoscale Hybrid Microscope VN-8000”) and evaluated for flatness by the following criteria.
A: Arithmetic surface roughness Ra: less than 10 nm
C: Arithmetic surface roughness Ra: 10 nm or more

(Transparency)

A nonalkali glass substrate was coated with a resin composition by the spin coating method, a hot plate was used to prebake this under conditions of 100° C. and 2 minutes, then an oven was used to cure this in an air atmosphere under conditions of 180° C. for 3 hours to thereby form a thickness 2 μm resin film. Further, the obtained resin film was measured for the transmittance at 1 nm intervals in a wavelength 400 to 700 nm range using a spectrophotometer (made by JASCO, “Ultraviolet Visible Spectrophotometer V-560”). Further, the average value of the total tranmisstance in the obtained 400 to 700 nm range was found and the transparency evaluated in accordance with the following criteria. Note that, the higher the transparency of the resin film, the higher the obtained laminate that can be judged in transparency.
A: Total transmittance of 95% or more
C: Total transmittance of less than 95%

### Synthesis Example 1

### Preparation of Cyclic Olefin Polymer (A-1)

100 parts of monomer mixture comprised of 40 mol % of N-phenyl-bicyclo[2.2.1]hept-5-ene-2,3-dicarboxyimide (NBPI) and 60 mol % of 4-hydroxycarbonyltetracyclo[6.2.1.1^{3,6}.0^{2,7}]dodec-9-ene (TCDC), 2.0 parts of 1,5-hexadiene, 0.02 part of (1, 3-dimesitylimidazolin-2-ylidene)(tricyclohexylphosphine)benzylidene ruthenium dichloride (synthesized by method described in Org. Lett., vol. 1, pp. 953, 1999), and 200 parts of diethyleneglycolethylmethyl ether were charged into a nitrogen-substituted glass pressure-resistant reactor and stirred while making them react at 80° C. for 4 hours to obtain a polymerization reaction solution.

Further, the obtained polymerization reaction solution was placed in an autoclave and stirred at 150° C. at a hydrogen pressure 4 MPa for 5 hours for a hydrogenation reaction to obtain a polymer solution which contains a cyclic olefin polymer (A-1). The polymerization conversion rate of the obtained cyclic olefin polymer (A-1) was 99.7%, the weight average molecular weight converted to polystyrene was 7,150, the number average molecular weight was 4,690, the molecular weight distribution was 1.52, and the hydrogenation rate was 99.7%. Further, the solid content concentration of the polymer solution of the obtained cyclic olefin polymer (A-1) was 34.4 wt %.

### Synthesis Example 2

### Preparation of Acrylic Resin (A′-2)

20 parts of styrene, 25 parts of butyl methacrylate, 25 parts of 2-ethylhexylacrylate, 30 parts of methacrylate, 0.5 part of 2,2-azobisisobutyronitrile, and 300 parts of propyleneglycolmonomethyl ether acetate were stirred in a nitrogen stream while heating at 80° C. for 5 hours. The obtained resin solution was concentrated by a rotary evaporator to obtain a solid content concentration 35 wt % polymer solution of the acrylic resin (A′-2).

### Example 1

291 parts of the polymer solution of the cyclic olefin polymer (A-1) obtained in Synthesis Example 1 (as cyclic olefin polymer (A-1), 100 parts) as a cyclic olefin polymer (A), 10 parts of epoxylated butane tetracarboxylic acid tetrakis(3-cyclohexenylmethyl)-modified ε-caprolactone (aliphatic cyclic tetrafunctional epoxy resin, product name “Epolide GT401”, made by Daicel) as a cross-linking agent (B), 1 part of dipentaerythritol penta/hexaacrylate (product name “Aronix M-406 Penta 25-35%”, made by Toagosei, tetrafunctional or higher functional (meth)acrylate compound) as a (meth)acrylate compound (C), 2 parts of 3,4-epoxycyclohexylmethyl methacrylate (product name “Cyclomer M100”, made by Daicel, epoxy-group containing (meth)acrylate compound) as a (meth)acrylate compound (C), 2 parts of 2-hydroxy-1-{4-[4-(2-hydroxy-2-methylpropionyl)benzyl]phenyl}-2-methyl-p ropan-1-one (product name “Irgacure 127”, made by BASF) as a radical generator (D), 2 parts of pentaerythritoltetrakis[3-(3,5-di-t-butyl-4-hydroxyphenyl)propionate](product name “Irganox 1010”, made by BASF) as an antioxidant (E), and 100 parts of ethyleneglycol ethylmethyl ether as a solvent were mixed and made to dissolve, then the result was filtered by a pore size 0.45 μm polytetrafluoroethylene filter to prepare a solid content concentration 20% resin composition.

Further, the above obtained resin composition was used in accordance with the above method to evaluate the adhesion of the resin film and film, flatness, and transparency. The results are shown in Table 1.

### Example 2

Except, when preparing the resin composition, further adding 2 parts of 3-acryloxypropyltrimethoxysilane (product name “KBM-5103”, made by Shin-Etsu Chemical, alkoxysilyl-group containing (meth)acrylate compound) as a (meth)acrylate compound (C), the same procedure was followed as in Example 1 to obtain a resin composition and the same procedure was followed to evaluate it. The results are shown in Table 1.

### Example 3

Except, when preparing the resin composition, not using 3,4-epoxycyclohexylmethyl methacrylate as a (meth)acrylate compound (C), the same procedure was followed as in Example 1 to obtain a resin composition and the same procedure was followed to evaluate it. The results are shown in Table 1.

### Examples 4 and 5

Except, when preparing the resin composition, changing the amount of epoxylated butane tetracarboxylic acid tetrakis(3-cyclohexenylmethyl)-modified ε-caprolactone as a cross-linking agent (B) from 10 parts to 20 parts (Example 4) and to 30 parts (Example 5) respectively, the same procedure was followed as in Example 1 to obtain a resin composition and the same procedure was followed to evaluate it. The results are shown in Table 1.

### Example 6

Except, when preparing the resin composition, changing the amount of dipentaerythritol penta/hexaacrylate as a (meth)acrylate compound (C) from 1 part to 6 parts, the same procedure was followed as in Example 1 to obtain a resin composition and the sane procedure was followed to evaluate it. The results are shown in Table 1.

### Comparative Example 1

Except, when preparing the resin composition, changing the amount of epoxylated butane tetracarboxylic acid tetrakis(3-cyclohexenylmethyl)-modified ε-caprolactone as a cross-linking agent (B) from 10 parts to 50 parts, the same procedure was followed as in Example 1 to obtain a resin composition and the same procedure was followed to evaluate it. The results are shown in Table 1.

### Comparative Example 2

Except, when preparing the resin composition, changing the amount of dipentaerythritol penta/hexacrylate as a (meth)acrylate compound (C) from 1 part to 10 parts, the same procedure was followed as in Example 1 to obtain a resin composition and the sane procedure was followed to evaluate it. The results are shown in Table 1.

### Comparative Example 3

Except, when preparing the resin composition, using 281 parts of the polymer solution of the acrylic resin (A′-2) (as acrylic resin (A′-2), 100 parts) instead of the polymer solution of the cyclic olefin polymer (A-1), the same procedure was followed as in Example 1 to obtain a resin composition and the same procedure was followed to evaluate it. The results are shown in Table 1.

TABLE 1

| Examples | | | | | | Comparative Examples | | |
|---|---|---|---|---|---|---|---|---|
| 1 | 2 | 3 | 4 | 5 | 6 | 1 | 2 | 3 |

Composition of resin film

| | | | | | | | | | | | |
|---|---|---|---|---|---|---|---|---|---|---|---|
| Resin | Cyclic olefin polymer (A-1) | (parts) | 100 | 100 | 100 | 100 | 100 | 100 | 100 | 100 | — |
| | Acrylic resin (A′-2) | (parts) | — | — | — | — | — | — | — | — | 100 |
| Cross-linking agent | Epolide GT401 | (parts) | 10 | 10 | 10 | 20 | 30 | 10 | 50 | 10 | 10 |
| (B) | | | | | | | | | | | |
| (Meth)acrylate | Aronix M-406 | (parts) | 1 | 1 | 1 | 1 | 1 | 6 | 1 | 10 | 1 |
| compound (C) | Cyclomer M100 | (parts) | 2 | 2 | — | 2 | 2 | 2 | 2 | 2 | 2 |
| | KBM-5103 | (parts) | — | 2 | — | — | — | — | — | — | — |
| Radical generator (D) | Irgacure 127 | (parts) | 2 | 2 | 2 | 2 | 2 | 2 | 2 | 2 | 2 |
| Antioxidant (E) | Irganox 1010 | (parts) | 2 | 2 | 2 | 2 | 2 | 2 | 2 | 2 | 2 |

Evaluation

| | | | | | | | | | | |
|---|---|---|---|---|---|---|---|---|---|---|
| Adhesion between resin film and film (cross- | Using | A | A | A | A | B | B | C | C | B |
| cut test) | PEN film | | | | | | | | | |
| | Using | — | A | — | A | — | — | — | — | — |
| | PET film | | | | | | | | | |
| Flatness | | A | A | A | A | A | A | A | A | C |
| Transparency | | A | A | A | A | A | A | A | A | A |

### In Table 1,

“Epolide GT401” is epoxylated butane tetracarboxylic acid tetrakis(3-cyclohexenylmethyl)-modified ε-caprolactone,
“Aronix M-406” is dipentaerythritol penta/hexaacrylate,
“Cyclomer M100” is 3,4-epoxycyclohexylmethyl methacrylate,
“KBM-5103” is 3-acryloxypropyltrimethoxysilane,
“Irgacure 127” is 2-hydroxy-1-{4-[4-(2-hydroxy-2-methylpropionyl)benzyl]phenyl}-2-methylpr opan-1-one, and
“Irganox 1010” is pentaerythritol tetrakis[3-(3,5-di-t-butyl-4-hydroxyphenyl)propionate].

As shown in 1, when using a resin composition containing a cyclic olefin polymer (A), cross-linking agent (B), (meth)acrylate compound (C), radical generator (D), and antioxidant (E), having a content of cross-linking agent (B) with respect to 100 parts by weight of the cyclic olefin polymer (A) of 5 to 40 parts, and having a content of the (meth)acrylate compound (C) of 0.5 to 10 parts, the result becomes excellent in adhesion of the resin film and the base film and excellent in flatness and transparency. From the result, the laminate of the present invention is excellent in interlayer adhesion and excellent in flatness and transparency and can be judged suitable for application of a protective board for flexible organic EL display (Examples 1 to 6).

On the other hand, when making the amount of the cross-linking agent (B) over 40 parts and when making the amount of the (meth)acrylate compound (C) over 10 parts, the result becomes poor in adhesion of the resin film and the base film (Comparative Examples 1 and 2).

Further, when using, instead of the cyclic olefin polymer (A), an acrylic resin, the result became insufficient flatness (Comparative Example 3).

1. A laminate obtained by forming a resin film on a base film with a glass transition temperature of 60 to 160° C., wherein
the resin film is formed using a resin composition containing a cyclic olefin polymer (A) having a protonic polar group, a cross-linking agent (B), a (meth)acrylate compound (C), a radical generator (D), and an antioxidant (E), and
a content of the cross-linking agent (B) in the resin composition is 5 to 40 parts by weight with respect to 100 parts by weight of the cyclic olefin polymer (A) having a protonic polar group, and a content of the (meth)acrylate compound (C) in the resin composition is 0.5 to 10 parts by weight.

2. The laminate according to claim 1 wherein a content of the radical generator (D) in the resin composition is 0.3 to 8 parts by weight with respect to 100 parts by weight of the cyclic olefin polymer (A) having a protonic polar group.

3. The laminate according to claim 1 wherein a content of the antioxidant (E) in the resin composition is 0.1 to 20 parts by weight with respect to 100 parts by weight of the cyclic olefin polymer (A) having a protonic polar group.

4. The laminate according to claim 1 wherein the (meth)acrylate compound (C) includes at least one of an alkoxysilyl group-containing (meth)acrylate compound, epoxy group-containing (meth)acrylate compound, and tetrafunctional or higher functional (meth)acrylate compound.

5. The laminate according to claim 1 wherein the antioxidant (E) is a phenol-based antioxidant.

6. The laminate according to claim 1 wherein the base film is a polyethylene naphthalate film.

7. The laminate according to claim 1 which is used as a protective board for a flexible organic EL display.
